(19) United States
(12) Patent Application Publication
(10) Pub. No.: US 2018/0133988 A1
(43) Pub. Date: May 17, 2018

(54) POLYMERIC GRADIENT OPTICAL ELEMENT AND METHODS OF FABRICATING

(71) Applicant: PolymerPlus LLC, Valley View, OH (US)

(72) Inventor: Michael T. Ponting, Valley View, OH (US)

(21) Appl. No.: 15/816,433

(22) Filed: Nov. 17, 2017

Related U.S. Application Data
(60) Provisional application No. 62/423,504, filed on Nov. 17, 2016.

(51) Int. Cl. B29D 11/00; G02B 1/04; G02B 3/00

(52) U.S. Cl. CPC B29D 11/00355; B29K 2069/00; G02B 3/0087; G02B 1/041

(57) ABSTRACT

A multilayered gradient optical element includes a thermoformed multilayered polymer material having a gradient in at least one optical property that is defined a gradient in concentration of at least one optical additive in the layers of the material. The thermoformed multilayered material includes a consolidated plurality of extruded polymer films having varying concentrations of the at least one optical additive.

### RELATED APPLICATION

This application claims priority from U.S. Provisional Application No. 62/423,504, filed Nov. 17, 2016, the subject matter of which is incorporated herein by reference in its entirety.

### BACKGROUND

Polymers, polymer composites, and/or polymers containing inorganic or metallic nanoparticles can be extruded to provide materials with thousands of layers. The polymeric materials in the layers can be chosen to have substantial differences in the index of refraction so that the resulting materials will possess a modulation in the index with a period corresponding to the layer thickness. Layer thickness down to 5 nm can be readily produced. Nazarenko et al. in “Polymer microlayer structures with anisotropic conductivity”, Journal of Materials Science, 34(7), 1461 (1999) and Mueller et al in Polymer Engineering and Science, 37(2), 355 (1997) describe the basic ideas for fabrication and the use of such materials to make dielectric reflectors. Methods of fabricating dielectric reflectors and filters with specific transmission properties and pass bands are described in P. Yeh; “Optical Waves in Layered Media”, Wiley, New York, (1998). Properly oriented layered birefringence polymers can give multilayer mirrors that maintain reflectivity over a broad band of incident angles.

A variety of methods have been developed for producing materials with a variation in the index of refraction that is suitable for gradient refractive index (GRIN) optics. Polymer GRIN lenses are often fabricated by copolymerization (Y. Ohtsuka, et al, “Studies on the light-focusing plastic rod. 10:A light-focusing plastic fiber of methyl methacrylate-vinyl benzoate copolymer”, Applied Optics, 20, (15), 2726 (1981), and Y. Ohtsuka and Y. Koike, “Studies on the light-focusing plastic rod. 18: Control of refractive-index distribution of plastic radial gradient-index rod by photocopolymerization”, Applied Optics, 24(24), 4316 (1985)) of two different monomers undergoing diffusion. Incomplete diffusion leads to a composition gradient and hence an index gradient across the material. Most of these techniques result in small lenses, less than 10 mm diameter. The index gradients are small; the largest index variations are typically on the order of 0.01 to 0.03. Usually the index gradients are monotonic and the variation of index with distance is limited to those that can be achieved by the laws of diffusion.

Other techniques to produce a composition gradient include dopant diffusion and centrifugation. Complex mixing and extrusion techniques have also been proposed. The polymer copolymerization techniques are effective only if the components are miscible over all ranges of polymerization. Polymeric materials made by dopant diffusion are often short lived because of migration of the dopants. The mixing/extrusion techniques involve many control variables that are difficult to control and in addition they can only be used with polymers that are miscible over a wide range of compositions.

### SUMMARY

Embodiments described herein relate to consolidated multilayer polymeric gradient optical materials, methods of fabricating consolidated multilayer polymeric gradient optical materials, and polymeric gradient optical elements formed from the consolidated multilayer polymeric gradient optical materials. The consolidated multilayer polymeric gradient optical materials can include a thermoformed multilayered polymer sheet having a gradient in at least one optical property that is defined by a gradient in concentration of at least one optical additive in the layers of the sheet.

In some embodiments, the gradient of optical properties, which are defined by the gradient in concentration of at least one optical additive, can include at least one of absorption, reflection, refraction, transmission, polarization, and/or scattering. The gradient in optical properties can be tailored to allow for enhanced absorption, reflection, refraction, transmission, polarization, and/or scattering in desired regions of the optical material or optical elements formed therefrom by defining the concentration of the at least one optical additive in select or desired regions or portions of the optical materials or optical elements. For example, large optical responses, such as filtration/reflection, up to 725 times that of conventional optical materials, such as optical silica glass, can be readily achieved using consolidated multilayer polymeric gradient optical materials and polymeric gradient optical elements described herein. This degree of reflection can yield protection for persons, sensors, and or temperature sensitive components when placed between a high intensity energy source and a receptor. Advantageously, the consolidated multilayer polymeric gradient optical material and polymeric gradient optical elements described herein can be provided at a lower material cost and improved performance compared to conventional uniformly doped reflecting or nonlinear absorbing optical elements by utilizing layer based concentration gradients to selectively steer light toward or away from areas of potential concern or damage, such as optical sensors or the human retina.

In some embodiments, a method of fabricating a consolidated multilayered gradient optical element can include extruding a polymer component blended with varying amounts of at least one optical additive to form a plurality of films having varying concentrations of the at least one optical additive. The plurality of films can then be consolidated into a multilayered sheet having a gradient in optical properties defined by a gradient in concentration of the at least optical additive in the layers of the sheet. The consolidated multilayered sheet can then be shaped into the consolidated gradient optical element.

In some embodiments, the concentration of the optical additives in the multilayered sheet varies across a plain parallel to a thickness of the multilayered sheet to define the gradient in optical properties. In other embodiments, the concentration of the optical additives in the multilayered sheet varies across a plain normal to a thickness of the multilayered sheet to define the gradient in optical properties.

In some embodiments, the plurality of films can be consolidated by stacking the films and laminating the films under pressure to obtain a flat multilayered sheet. The films can be stacked in ordered layers to form a hierarchical multilayered gradient sheet such that adjacent films are selected to exhibit progressively different optical properties. Each layer of the sheet can have a thickness that is defined the thickness of the respective film. The thicknesses of each film can be the same or different and be, for example, from about 5 nm to about 1,000 μm. The sheet can include from 5 to about 100,000 films that are consolidated to from the layers of the sheet.

In some embodiments, the polymer component can include a thermoplastic polymer that can be readily extruded with the at least one optical additive such that the optical additive is not degraded at the extrusion temperature of the thermoplastic polymer. The thermoplastic polymer can be selected from the group consisting of polyethylene naphthalate, an isomer thereof, a polyalkylene terephthalate, a polyimide, a polyetherimide, a styrenic polymer, a polycarbonate, a poly(meth)acrylate, a cellulose derivative, a polyalkylene polymer, a fluorinated polymer, a chlorinated polymer, a polysulfone, a polyethersulfone, polyacrylonitrile, a polyamide, polyvinylacetate, a polyether-amide, a styrene-acrylonitrile copolymer, a styrene-ethylene copolymer, poly(ethylene-1,4-cyclohexylenedimethylene terephthalate), polyvinylidene difluoride, an acrylic rubber, isoprene, isobutylene-isoprene, butadiene rubber, butadiene-styrene-vinyl pyridine, butyl rubber, polyethylene, chloroprene, epichlorohydrin rubber, ethylene-propylene, ethylene-propylene-diene, nitrile-butadiene, polyisoprene, silicon rubber, styrene-butadiene, urethane rubber, and polyoxyethylene, polyoxypropylene, and tetrafluoroethylene hexafluoropropylene vinylidene (THV), aromatic polyesters, aromatic polyamides, ethylene norbornene copolymers and blends thereof. For example, the polymer component can include a polycarbonate.

In other embodiments, the at least one optical additive is substantially non-migratory upon consolidation of the films and/or thermoforming of the sheet to provide the layers of the sheet with finite optical additive concentrations which are defined by the concentrations of the at least one optical additive in the films prior to consolidation. At least one optical additive can exhibit nonlinear optical effects, such as at least one of absorption, reflection, refraction, transmission, polarization, and/or scattering and can include, for example, an organic or inorganic dye, pigment, and/or nanomaterial.

In some embodiments, the consolidated multilayered sheet can be shaped into the consolidated gradient optical element by thermoforming the sheet. The sheet prior to thermoforming can have a substantially flat outer surface and an axial gradient of the at least one optical additive normal to the sheet outer surface.

In some embodiments, the thermoformed sheet can have a crescent shape and a spherical gradient concentration of the at least one optical additive. The sheets can be shaped into a lens or flat having at least one of an axial or radial gradient of optical properties.

### BRIEF DESCRIPTION OF THE DRAWINGS

The foregoing and other features and advantages of the present invention will become apparent to those skilled in the art to which the present invention relates upon reading the following description with reference to the accompanying drawings, in which:

FIG. 1 is a schematic illustration depicting a fabrication approach to produce a nonlinear optically absorbing/reflecting radial gradient optical flat.

FIG. 2 illustrates a plot showing variation of characterized UV-vis absorbance spectrum of nonlinear PbPc(CP)4 dye doped polycarbonate films with 1 wt. %, 3 wt. %, or 4.5 wt. % loading.

FIG. 3 illustrates a spherical gradient preform cross-section comprised of the film stacking formulation described in Table 2.

### DETAILED DESCRIPTION

Embodiments described herein relate to consolidated multilayer polymeric gradient optical materials, methods of fabricating consolidated multilayer polymeric gradient optical materials, and polymeric gradient optical elements formed from the consolidated multilayer polymeric gradient optical material. The consolidated multilayer polymeric gradient optical materials can include a thermoformed multilayered polymer sheet having a gradient in at least one optical property that is defined by a gradient in concentration of at least one optical additive in the layers of the sheet. The gradient of optical properties, which are defined by the gradient in concentration of at least one optical additive, can include at least one of absorption, reflection, refraction, transmission, polarization, and/or scattering. The gradient in optical properties can be tailored to allow for enhanced or varied absorption, reflection, refraction, transmission, polarization, and/or scattering in desired regions of optical material or optical elements formed therefrom by defining the concentration of the at least one optical additive in select or desired regions or portions optical material or optical elements.

For example, large optical responses, such as filtration/reflection, up to 725 times that of conventional optical materials, such as optical silica glass, can be readily achieved using consolidated multilayer polymeric gradient optical material and polymeric gradient optical elements described herein. Advantageously, the consolidated multilayer polymeric gradient optical material and polymeric gradient optical elements described herein can be provided at a lower material cost and improved performance compared to conventional uniformly doped reflecting or nonlinear absorbing optical elements.

Consolidated multilayer polymeric gradient optical materials and/or polymeric gradient optical elements formed therefrom with spatially variable optical properties can be used to form vision and/or optical sensors based on light intensity filtration as well as provide protection for persons, sensors, and or temperature sensitive components when placed between a high intensity energy source and a receptor. In some embodiments, the consolidated multilayer polymeric gradient optical materials or polymeric gradient optical elements formed therefrom can be used in anti-dazzling applications to reflect high intensity concentrated laser beams and protect vision of a subject (e.g., military personnel) as well as in electronic aviation laser guidance and tracking sensors/cameras that can be saturated and rendered non-responsive or non-functional by direct exposure to high intensity laser light. The ability to concentrate the optical properties of an optical material to specific spatial regions of an optical element, such as a visor, goggle, rifle scope, or sensor, enable further functionality in the non-sight critical areas of the optical element while reducing material cost as well as allows for production of optical lenses/elements capable of the high transmission/low scattering, which is often required for imaging technologies.

The term “gradient” as used herein refers to a variation of an optical property or characteristic from one part of the optical material or optical element described herein to another and can be used in relation to variations in one or more of light absorption, reflection, refraction, transmission, polarization, and/or scattering. Typically, such variations can be gradual and smooth, but the variation may be sharp and sudden, such as a boundary horizontally across a lower region of an optical element, such as a lens, below which one degree of light absorption, reflection, refraction, transmission, polarization, and/or scattering is provided and above which another different degree of light absorption, reflection, refraction, transmission, polarization, and/or scattering is provided.

In some embodiments, the gradient optical material (e.g., sheet) or optical element described herein can include variations in the optical properties of the material or element along an optical axis or normal to an optical axis of the optical material or optical element. The variations in the optical properties can also be in a plane that is normal to an outer surface of the material or element. Where the optical material or optical element is a vertically stacked multilayered sheet that includes an outer surface that lies generally in an x-y plane of x-y-z coordinate system, the variations in optical properties can be in the thickness of optical sheet or z direction of the optical sheet. In other embodiment, the variations in the optical properties can be in the x-y direction of optical sheet. It will be appreciated that the optical material or element can include variations in optical properties or gradient optical properties in the z direction concurrently with variations or gradients in the optical properties of the x direction and/or y direction and, as such, gradient optical materials or optical elements can be formed with variation in one, two, or all three of the mutually orthogonal directions. For example, a gradient optical element having a spherical shape can have an axial, radial, and/or spherical gradient in optical properties.

In some embodiments, the consolidated multilayer polymeric gradient optical materials used to form the optical element can be fabricated in a multi-stage process. In the multi-stage process a polymer component can be blended with varying amounts of at least one optical additive and extruded to form a plurality of polymer films having varying concentrations of the at least one optical additive. The plurality of films can then be consolidated into a multilayered sheet having a gradient in optical properties defined by a gradient in concentration of the at least optical additive in the layers of the sheet. The consolidated multilayered sheet can then be shaped into the consolidated gradient optical element.

The polymer films that include the varying concentrations of the optical additive can include a single extruded layer or multiple coextruded layers. In some embodiments, the polymer films can include a plurality (e.g., 2, 4, or more) of layers alternating between at least two, three, or more polymer types, with potentially differing optical additives and/or optical additive concentrations.

In one example, the films can include layers layer(s) of type (A), which are formed of a first polymer component, optical additive and/or optical additive concentration, and layer(s) of type (B), which are formed of a second polymer component, optical additive, and/or optical additive concentration. The layers of type (A) and (B) can be alternated so that multilayered film has a two component structure of alternating layers (ABABAB . . . ) or (AB)ₓ, where x is at least 2.

In another example, the films can include layers of type (A), (B), and (C). Layer(s) of type (A), can be formed of a first polymer component, optical additive and/or optical additive concentration, layer(s) of type (B), can be formed of a second polymer component, optical additive, and/or optical additive concentration, and layer(s) of type (C), can be formed of a third polymer component, optical additive, and/or optical additive concentration. Layer (B) can separate layers (A) and (C) to provide a three component layered structure of (ABC). In other embodiments, layer (A), layer (B), and layer (C) can be alternated so that the multicomponent layered dielectric film has a three component structure of alternating layers (ABCABCABC . . . ) or (ABC)ₓ, where x is at least 2. It will be appreciated that the first layer, second layer, and third layer can be provided any number of different component layers such as (CACBCACBC . . . ).

In some embodiments, the polymer component, optical additive, and/or optical additive concentration of the layers (A) can be the same as the layers (B). In other embodiments, at least one of the layers can be free of an optical additive and act as either a diffusion boundary to inhibit diffusion of an adjacent layer, which includes a concentration of the optical additive, or as a diffusion layer to facilitate diffusion of the optical additives from an adjacent or adjoining layer. For example, where the polymer film has an (ABC)ₓ construction, where x is at least one, layer (B) can be formed of a polymer component that is free of optical additives but act as a diffusion boundary between layers (A) and (C), which each include a concentration of the optical additive, thus preventing the diffusion of the optical additives of layers (A) and/or (C) into each other.

The polymer films can be fabricated with a predetermined range of absorption, reflection, refraction, transmission, polarization, and/or scattering and with an arbitrarily small difference between them. This may be done, for example, by altering the relative thicknesses of the films, the layers used form the films, the polymer components of the films, the optical additives, and/or optical additive concentration. In some embodiments, the concentration of optical additives in the polymer films can be varied by about 0.0001 wt. %, 0.0005 wt. %, 0.001 wt. %, 0.005 wt. %, 0.01 wt. %, 0.05 wt. %, 0.1 wt. %, 0.5 wt. %, 1 wt. %, 5 wt. %, 10 wt. %, 50 wt. % or more or less.

In some embodiments, each of the polymer films can have a microlayer or nanolayer thickness. By microlayer thickness it is meant that each of the films has a micron thickness and is between about 1 μm and about 1000 μm, about 10 μm and about 900 μm, or about 100 μm and about 750 μm. By nanolayer thickness it is meant that each of the films has a sub micron thickness and is less than about 1000 nm, less than about 500 nm, less than about 100 nm, or less than about 50 nm. In other embodiments, where the polymer films are composed multiple layer, each layer of the polymer film can have a sub micron thickness that can be less than about 1000 nm, less than about 500 nm, less than about 100 nm, less than about 50 nm, less than about 25 nm, or less than about 10 nm.

In other embodiments, each of the polymers can have a substantially uniform thickness in the range of about 5 nm to about 1,000 μm, about 50 nm to about 500 μm, or about 500 nm to about 50 μm.

The term “about” is used herein to denote a deviation from the stated value. In some embodiments, the polymeric materials used in the polymer films can be optically transparent at the layer thicknesses. The layer thickness can be varied or chirped to provide variable transparency, filtering, or reflectivity over a broad band of wavelengths and acceptance angles. Preferably, the films have substantially uniform layer thickness, where “substantially” is used to denote a deviation within 20%.

A wide variety of polymeric materials can be used as the polymer components. Such materials can include but are not limited to elastomers, thermoplastic, and/or oligomeric materials. The term “polymer” or “polymeric material” as used herein denotes a material having a weight average molecular weight (MW) of at least 5,000. The polymer may, for example, be an organic polymeric material. The term “oligomer” or “oligomeric material” as used herein denotes a material having a weight average MW from 1,000 to less than 5,000. Such oligomeric materials can be, for example, glassy, crystalline or elastomeric polymeric materials.

In some embodiments, the polymer component can include a thermoplastic polymer that can be readily extruded with the at least one optical additive such that the optical additive is not degraded at the extrusion temperature of the thermoplastic polymer.

Examples of polymeric materials that can be used as the polymer components can include but are not limited to aliphatic, polycarbonate based thermoplastic polyurethanes, thermoplastic elastomers, polytetramethylene glycol based polyurethane elastomers, polyethylene naphthalate and isomers thereof, such as 2,6-, 1,4-, 1,5-, 2,7-, and 2,3-polyethylene naphthalate; polyalkylene terephthalates such as polyethylene terephthalate, polybutylene terephthalate, and poly-1,4-cyclohexanedimethylene terephthalate; aromatic polyesters (e.g., Osaka Gas Company OKP4 and OKP4HT), polyimides, such as polyacrylic imides; polyetherimides; styrenic polymers, such as atactic, isotactic and syndiotactic polystyrene, α-methyl-polystyrene, para-methyl-polystyrene; polycarbonates such as bisphenol-A-polycarbonate (PC); poly(meth)acrylates such as glassy poly(methyl methacrylate), poly(methyl methacrylate), poly(isobutyl methacrylate), poly(propyl methacrylate), poly(ethyl methacrylate), poly(butyl acrylate) and poly(methyl acrylate) (the term “(meth)acrylate” is used herein to denote acrylate or methacrylate); cellulose derivatives, such as ethyl cellulose, cellulose acetate, cellulose propionate, cellulose acetate butyrate, and cellulose nitrate; polyalkylene polymers, such as polyethylene, polypropylene, polybutylene, polyisobutylene, and poly(4-methyl)pentene; fluorinated polymers, such as perfluoroalkoxy resins, polytetrafluoroethylene, fluorinated ethylene-propylene copolymers, polyvinylidene fluoride, and polychlorotrifluoroethylene and copolymers thereof; chlorinated polymers, such as polydichlorostyrene, polyvinylidene chloride and polyvinylchloride; polysulfones; polyethersulfones; polyacrylonitrile; polyamides; polyvinylacetate; aromatic polyamides (e.g., amorphous nylons, such as Dupont Sellar or EMS G21), and polyether-amides.

Other polymer materials that can be used as the polymer components to form the polymer films are copolymers, such as styrene-acrylonitrile copolymer (SAN), for example, containing between 10 and 50 wt %, or between 20 and 40 wt %, acrylonitrile, SAN-17, styrene-ethylene copolymer; and poly(ethylene-1,4-cyclohexylenedimethylene terephthalate) (PETG). Additional polymeric materials include an acrylic rubber; electro-optic polymers, such as polyoxyethylene (EO) or polyoxypropylene (PO); tetrafluoroethylene hexafluoropropylene vinylidene (THV); isoprene (IR); isobutylene-isoprene (IIR); butadiene rubber (BR); butadiene-styrene-vinyl pyridine (PSBR); butyl rubber; polyethylene; chloroprene (CR); epichlorohydrin rubber; ethylene-propylene (EPM); ethylene-propylene-diene (EPDM); nitrile-butadiene (NBR); polyisoprene; silicon rubber; styrene-butadiene (SBR); ethylene norbornene copolymers (e.g., Zeonex, and Topaz), and urethane rubber. Still, additional polymeric materials include liquid crystalline polymers, copolymers, and block or graft copolymers.

In other embodiments, the polymer component is selected from the group consisting of polyethylene naphthalate, an isomer thereof, a polyalkylene terephthalate, a polyimide, a polyetherimide, a styrenic polymer, a polycarbonate, a poly(meth)acrylate, a cellulose derivative, a polyalkylene polymer, a fluorinated polymer, a chlorinated polymer, a polysulfone, a polyethersulfone, polyacrylonitrile, a polyamide, polyvinylacetate, a polyether-amide, a styrene-acrylonitrile copolymer, a styrene-ethylene copolymer, poly(ethylene-1,4-cyclohexylenedimethylene terephthalate), polyvinylidene difluoride, an acrylic rubber, isoprene, isobutylene-isoprene, butadiene rubber, butadiene-styrene-vinyl pyridine, butyl rubber, polyethylene, chloroprene, epichlorohydrin rubber, ethylene-propylene, ethylene-propylene-diene, nitrile-butadiene, polyisoprene, silicon rubber, styrene-butadiene, urethane rubber, and polyoxyethylene, polyoxypropylene, and tetrafluoroethylene hexafluoropropylene vinylidene (THV), aromatic polyesters, aromatic polyamides, ethylene norbornene copolymers and blends thereof.

In some embodiments, the polymer components of the respective polymer films can be substantially miscible. Alternatively, one or more of the components of the respective polymer films may be immiscible or partially miscible.

The at least one optical additive that is blended with the polymer component and coextruded to form the polymer film can include any optical additive whose concentration or amount in the polymer film can be varied to vary the absorption, reflection, refraction, transmission, polarization, and/or scattering of the polymer film. The optical additive can be readily extruded with the polymer component such that the optical additive is not degraded at the extrusion temperature of the thermoplastic polymer. In some embodiments, the at least one optical additive is substantially non-migratory upon consolidation of the polymer films and/or thermoforming of the sheet formed from the polymer films to provide layers of a sheet formed from consolidated polymer films with finite optical additive concentrations which are defined by the concentrations of the at least one optical additive in the films prior to consolidation.

In some embodiments, the at least one optical additive can include, for example, an organic or inorganic dye, pigment, and/or nanomaterial that can exhibit nonlinear optical effects, such as at least one of absorption, reflection, refraction, transmission, polarization, and/or scattering. Non-limiting examples of organic or inorganic dyes, pigments, and/or nanomaterials that exhibit nonlinear optical effects include metal, semiconductor, and organic nanoparticles, including bismuth ferrite (BiFeO₃), cadmium sulfide (CdS), cadmium telluride (CdTe), carbon nanotubes, carbon nanowires, fullerenes (C60), graphite, graphene oxide, and carbon nanoparticles, zinc oxide (ZnO) and titanium dioxide (TiO₂) nanoparticles, gold (Au) and silver (Ag) metal nanoparticles, gold (Au) and silver (Ag) metal coated nanoparticles, silica and metal oxide capped gold (Au), copper (Cu), silver (Ag) metal nanoparticles, quantum dots, hybrid organic-inorganic nanoparticles bound to one or more nonlinear optical chromophores, stilbene-3, phyrins and derivatives, phthalocyanines (e.g., lead phtalocyanine (PbPc(CP)₄) dye), naphthalocyanines, and other classes of chromophores exhibit enhanced nonlinerar optical performance when incorporating a heavy metal atom (Pb, Au, Ag, Pt, Pd) as well as a combination of two or more of these optical additives with different geometries, such as fibers, or spheres.

Possible origins of nonlinearity effects of the optical additives may include intraband, interband, and hot-electron contributions. Intraband contributions are due to electron transitions within a single conduction band. Interband contributions are due to electron transitions from the d-band to the s-conduction-band. Last, hot-electron contributions are due to non-equilibrium heating of the conduction band electrons.

The nonlinear optical additives may also induce nonlinear response due to light induced plasmons or plasmonics. Plasmons occur when light interacts with the charge oscillations of the dye or particle resulting in resonances between the light frequency and oscillation frequency. These resonances cause absorption and scattering, characterized by a resonant frequency (or wavelength), over a spectral bandwidth. The frequency of the resonances can be tuned by the particle's size, geometry and organic-host type. A result of light absorption may be localized heating, which can also impart nonlinear properties.

Also, dyes may be attached to metal or semiconductor nanoparticles to enhance intermolecular charge transfer from a donor toward an acceptor and dipole moments that result from non-symmetrical charge distribution.

It will be appreciated that the optical properties (linear and non-linear) of the optical additives in the polymer component matrix are mainly dependent on the properties of the optical additive, the polymer component in which the optical additives are embedded, and the interaction between the optical additives and the polymer component.

It is preferred that the optical additives are uniformly dispersed in the respective polymer film prior to and after film consolidation to form the multilayer sheet.

The amount of optical additives that can be provided in the polymer films can be that amount effective to vary the optical properties of the polymer film. For example, the amount of optical additives can be about at least about 0.00001 wt. %, about 0.0001 wt. %, about 0.001 wt. %, about 0.01 wt. %, about 0.1 wt. %, about 1 wt. %, about 10 wt. %, or more.

The polymer films can be fabricated by extrusion, coextrusion or ordering through a feed block, multipliers/interfacial surface generators, and/or chaotic mixers. For example, multilayered polymer films may be formed by forced assembly co-extrusion in which one or more polymers blended with optical additives are layered and then multiplied several times or traditional multilayer coextrusion processing where layering is accomplished simultaneously in a single multilayered feed block. These processes can result in large area films (e.g., feet wide by yards wide) consisting of thousands of layers with individual layer thicknesses as thin as 5 nm. When the layer thickness is much less than the wavelength of light, the films behave as effective media and, thus, have unique properties compared to the constituents. The polymer films may have an overall thickness ranging from about 50 nm to about 10 cm, in particular from about 500 nm to about 10 μm including any increments within these ranges.

The polymer films can be stacked to form a hierarchical multilayer polymeric gradient optical sheet. The hierarchical multilayer polymeric gradient optical sheet may, for example, be formed by layering the polymer films in a hierarchical structure as described and disclosed in U.S. Pat. Nos. 6,582,807, 7,002,754, and 8,902,508, which are incorporated herein by reference in their entirety. By layering the polymer films, the hierarchical multilayer polymeric gradient optical sheet is given a gradient absorption, reflection, refraction, transmission, polarization, and/or scattering. The layering can be done so that the resulting hierarchical multilayer polymeric gradient optical sheet has a gradient of optical properties in any direction, such as the axial, radial or spherical direction. The gradient of optical properties can be continuous, discrete or stepped. Many gradients can be achieved within the limits imposed by the amount or concentration of the optical additives in the polymer films.

In any case, adjacent polymer films can be chosen to exhibit progressively different absorption, reflection, refraction, transmission, polarization, and/or scattering. For example, stacking 5 to 100,000 polymer films will form a hierarchical multilayer polymeric gradient optical sheet from which gradient optical element, such as a gradient optical lens, can be fabricated as described below. The gradient of optical properties of the hierarchical multilayer polymeric gradient optical sheet is determined by the design in which the polymer films are stacked. A particular advantage of this process is that any predetermined gradient can be easily achieved using polymer films. The gradient is limited only by the available range of optical properties of polymer films. Due to the aforementioned construction of the hierarchical multilayer polymeric gradient optical sheet, the sheet has a hierarchical structure on the nanometer scale, micrometer scale, and the centimeter scale.

The stacked polymer films can then be consolidated using heat and/or pressure to form a hierarchical multilayer polymeric gradient optical sheet. In some embodiments, the polymer films can be consolidated to form the hierarchical multilayer polymeric gradient optical sheet using autoclave consolidation techniques. In other embodiments, the polymer films can be consolidated using adhesive or adhesive layers that bind the stacked individual multilayer polymer films.

The hierarchical multilayer polymeric gradient optical sheet can be used to form a multilayer polymeric gradient optical material. In some embodiments, the multilayer polymeric gradient optical material can include just the hierarchical multilayer polymeric gradient optical sheet. In other embodiments, the multilayer polymeric gradient optical material can include other multilayer polymeric gradient optical sheet and/or other layers. Such other multilayer polymeric gradient optical sheet and/or other layers can have compositions that allow the optical properties of the multilayer polymeric gradient optical material to be varied. For example, the multilayer polymeric gradient optical material can include a reflector layer that is bonded to, consolidated with, and sandwiched between multilayer polymeric gradient optical sheets having different compositions. In other examples, the multilayer polymeric gradient optical material can include a filter layer that is bonded to and/or consolidated with the multilayer polymeric gradient optical sheet. Other additional layers, materials, sheets, and/or objects, can be provided with or consolidated with the multilayer composite multilayer polymeric gradient optical sheet to vary the optical properties of the multilayer polymeric gradient optical material.

In some embodiments, the consolidated multilayer polymeric gradient optical material can be formed into a polymeric gradient optical element, such as a polymeric gradient optical lens that has any predetermined spherical or aspherically symmetric axial or radial gradient of optical properties. The consolidated multilayer polymeric gradient optical material may be formed into a predetermined shape, such as a spherical or an aspherical shape, by heating the consolidated multilayer polymeric gradient optical material to a temperature below the melting temperature of any of the polymers within the consolidated multilayer polymeric gradient optical material. The heated consolidated multilayer polymeric gradient optical material can then be thermoformed in a die or mold forming the consolidated multilayer polymeric gradient optical material into the predetermined shape (e.g., a spherical or an aspherical surface shape) that is maintained when the heated consolidated multilayer polymeric gradient optical material cools.

In other embodiments, the consolidated multilayer polymeric gradient optical material can be formed into a polymeric gradient optical flat and/or polymeric gradient optical window, which does not have focusing power of an optical lens. The optical flats and/or windows can be used to provide light intensity protection to an existing optical device or design without changing the existing lens prescription/performance and/or causing a redesign or modification to the existing optical design of the device to focus at the correct distance for use with the operator's eyes or computer sensor spacing. The consolidated multilayer polymeric gradient optical material may be formed into a predetermined shape, of the optical flat and/or window, by heating the consolidated multilayer polymeric gradient optical material to a temperature below the melting temperature of any of the polymers within the consolidated multilayer polymeric gradient optical material. The heated consolidated multilayer polymeric gradient optical material can then be thermoformed in a die or mold forming the consolidated multilayer polymeric gradient optical material into the predetermined shape that is maintained when the heated consolidated multilayer polymeric gradient optical material cools.

Alternatively or additionally, the consolidated multilayer polymeric gradient optical material can be mechanically or chemically shaped by a suitable process, such as etching, patterning, diamond machining, metallurgical polishing, glass bead honing and the like, or a combination of diamond machining followed by metallurgical polishing or glass bead honing or the like to shape the consolidated multilayer polymeric gradient optical material into a desired shape (e.g., spherical or an aspherical shape).

Depending on the particular polymeric construction of the polymeric gradient optical element, the polymeric gradient optical element may be reversibly deformable or irreversible deformable. Accordingly, by using multilayered polymer technology, a polymeric gradient optical lens can be fabricated such that the gradient is varied dynamically and reversibly. This is accomplished, for example, by using dynamically variable multilayer polymeric components as the individual layers. In particular, alternation polymer layers can be fabricated such that the elastic moduli as well as the index of refraction of the alternating polymer layers are different. In these materials, applied stress, such as pressure, tension, compression or sheer stresses or a combination of these stresses, changes the relative layer thickness and, thus, changes the gradient in the lens.

The variation of optical properties and optical property gradient changes can also be achieved by any type of mechanical or electrical stimulus, or by magnets attached to the multilayer polymeric structure. The changes can be induced by electrostatic effects or by using electroactive or electrooptic component polymers. This provides the materials with a large electro-optical response. The sensitivity of the index to stress can be varied by the choice of the polymer components and optical additives relative initial thickness. Therefore, it is possible to fabricate a variable gradient lens where both the initial gradient and the variability of the gradient with stress can be predetermined.

Optionally, the gradient of the polymeric gradient optical element can varied, reversibly or irreversibly, by axially orienting (e.g., stretching) the consolidated multilayer polymeric gradient optical sheet and/or polymer films during and/or after fabrication. As pointed out above, the polymer film and hence the consolidated multilayer polymeric gradient optical sheet can be fabricated so that one or both of the component polymers is an elastomer. Axial orientation of the polymer film and/or consolidated multilayer polymeric gradient optical sheet in at least one direction parallel can vary the gradient distribution of the film or sheet. In one example, a polymer film can be biaxially oriented by stretching the film in a plane that is substantially parallel to a surface of the film. It will be appreciated that although the film can be biaxially oriented by stretching the film in at least two directions, the film can also be stretched in a single direction (e.g., uniaxially oriented) or stretched in multiple directions (e.g., biaxially or triaxially oriented).

In fabricating gradient optical lenses, flats, and/or windows, it is also desirable to be able to specify the gradient in optical properties from as small to as large as possible. With the multilayering technique described herein, a wide variety of gradients are possible. Since a larger gradient gives a wider range of gradient optical lenses that can be made, it is desirable to be able to make a large gradient.

An important point is that the multilayering technique described herein allows the use of miscible, immiscible or partially miscible polymers to achieve a large gradient difference. Other gradient lens and/or flat fabrication techniques use diffusion techniques to achieve gradients. Thus, the examples in the prior art are limited to small gradients of in the materials.

A second important point is that gradient optical elements can be designed to be used as optical elements over a wide wavelength range from near 40 nm to 1 meter. The specific wavelength range is determined by the polymeric components.

The polymeric gradient optical element described herein can be used in a wide range of applications. For example, optical elements can be utilized to protect biological-matter, protect sensors, or otherwise filter light. The optical element can be integrated into a window, display, eyewear, or heads-up display to protect the human eye from a laser or other intense light. The optical element can be integrated into waveguides and photonic circuits. The optical element can be integrated into systems that illuminate organic-matter such as optical microscopes, confocal microscopes, flow cytometers, optical DNA sequencing systems, laser scalpels, LASIK systems, light based periodontal equipment, and other such systems that provide light delivery for illumination of biological matter. The optical element can be placed or integrated within into photonic detector and photonics devices such as photodiodes, CCD arrays, pyro sensors, thermopiles and other such devices, either to protect the photonics devices from damage or allow for increased operational dynamic range in applications such as imaging, range finding, or spectroscopy. Alternatively the optical element could be used with, or integrated within, various light sources, such as black body sources, lasers, light emitting diodes, and diode lasers to either limit or stabilize the output. Further the optical element can be tailored for any aforementioned application with respect to spectral domain, time domain, or intensity, such as energy collection devices, solar cells, solar collectors, solar concentrators, beam shaping devices, and other devices that require a lens. Furthermore, the polymeric gradient optical elements may be used in biological implants such as synthetic copies of human lenses to produce implantable devices for human or animal vision.

The following Example describes a discovery in formulation and processing of nanolayered polymer films containing a polymer component and optical additives.

### Example

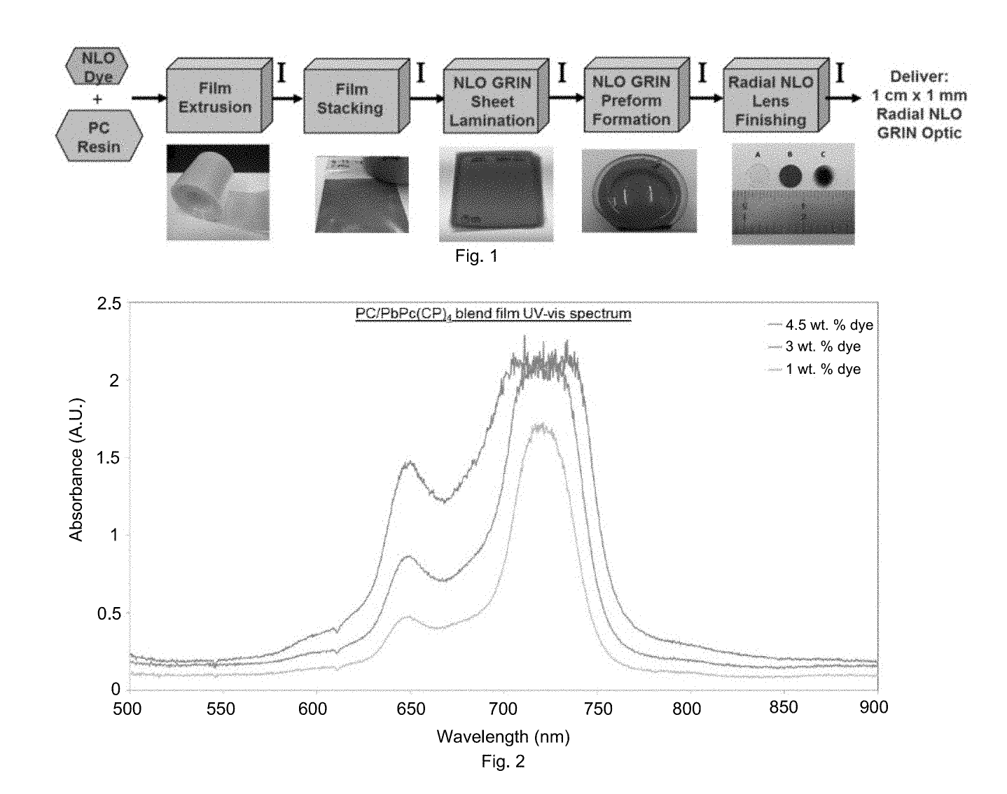

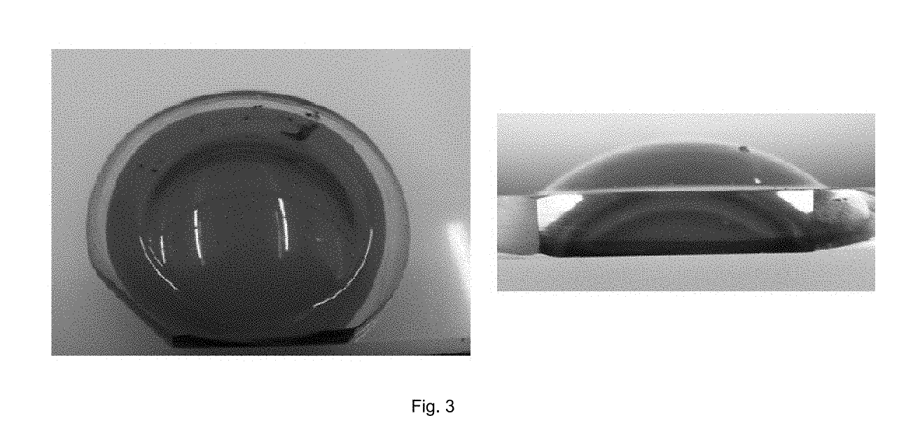

Optical parts (lens, optical flats) were created at with a varying optical absorption or reflection characteristic as a function of optic position based through a two part film extrusion and thermoforming process as shown FIG. 1. The polymer-optical component films utilized in this example were polycarbonate and a commercially obtained tetracumylphenoxy Lead Phthalocyanine [PbPc(CP)4] dye. In the first step of the process, an optically active component (organic/inorganic dye or particle) is blended into a matrix polymer (polycarbonate in this example) at a target loading and extruded into a thin film. A series of polymer films with varied optical component loading was produced and characterized to determine the effect on material optical absorption. Characterization of the series of extruded films produced a composition dependent change in optical absorption, Table 2, FIG. 2. Pieces of each dye loaded film were than stacked and laminated under pressure and heat to obtain a flat sheet with an axial gradient in dye concentration normal to part surface. Subsequent optical molding of the flat into a crescent shape transformed the axial dye concentration to a spherical dye concentration, FIG. 3. Diamond machining was next completed on the part to remove a thin equatorial slice of the spherical part to render a radial gradient of dye concentration in the polycarbonate disk with a difference of 725× in light absorption from the center to the edge of the part.

TABLE 1
Measured Z-scan absorption data of extruded polycarbonate films with increased
dye loading producing a range of variable absorbing optical films

| | | | | | | | 600 nm | | |
|---|---|---|---|---|---|---|---|---|---|
| | | | 600 nm | | 600 nm | | n2(cm\hat{ }2/ | | apprx |
| film | d(μ) | ± | α(cm\hat{ }−1) | ± | B(cm/GW) | ± | GW) | | wt |
| 9-11-14 10 | 130.8 | 13.8 | 30.0 | 3.6 | 0.67 | 0.06 | N/A | | 0.55 |
| 9-11-14 8 | 99.7 | 8.4 | 31.1 | 3.5 | 0.76 | 0.21 | N/A | | 0.58 |
| 9-11-14 7 | 95.3 | 16.3 | 38.1 | 6.9 | 0.73 | 0.08 | N/A | | 0.76 |
| 9-11-14 4 | 101.0 | 9.8 | 40.8 | 4.6 | 1.10 | 0.28 | N/A | | 0.84 |
| 9-11-14 9 | 106.0 | 21.6 | 41.1 | 8.6 | 0.90 | 0.15 | N/A | | 0.84 |
| 8-25-14 5 | 76.8 | 3.8 | 41.5 | 3.6 | 1.02 | 0.44 | N/A | | 0.85 |
| 8-25-14 8 | 63.5 | 7.5 | 45.9 | 6.5 | 0.42 | 0.11 | N/A | | 0.97 |
| 9-8-14 3 min | 99.1 | 10.4 | 101.4 | 10.9 | 3.24 | 0.57 | N/A | | 1.8 |
| 8-25-14 1 | 76.8 | 8.4 | 197.0 | 21.7 | 5.34 | 0.12 | 1.12E−04 | 3.00E− | 3.1 |
| 9-8-14 2 min | 109.2 | 6.2 | 243.6 | 14.0 | 8.09 | 0.88 | 1.74E−04 | 2.40E− | 3.7 |
| 9-8-14-1 min | 130.8 | 14.1 | 403.6 | 43.7 | N/A | N/A | N/A | | 6.1 |

TABLE 2
Variation of characterized UV-vis absorbance spectrum
of non-linear PbPc(CP)4 dye doped polycarbonate films
with 1%, 3%, or 4.5 wt. % loading

| | | | | Concentration |
|---|---|---|---|---|
| Film # | Pieces | Sheet Position | Preform Position | PbPC(CP)₄ |
| 1-7 | 4 | 0.32 | 0.24 | 5.0-7.5% |
| 8-12 | 3 | 0.56 | 0.42 | 3.75-5.0% |
| 13-16 | 2 | 0.72 | 0.54 | 2.0-3.75% |
| 17-18 | 1 | 0.8 | 0.6 | 1.25-2.0% |
| 19 | 1 | 0.88 | 0.66 | 1.00% |
| 20 | 1 | 0.96 | 0.72 | 0.75% |
| 21 | 1 | 1.04 | 0.78 | 0.50% |
| 22-25 | 1 | 1.12 | 0.84 | 0.25% |
| 26-151 | 62 | 6.08 | 4.56 | PC control |

Numerous modifications and variations of the present invention are possible in light of the above teachings. It is therefore to be understood that within the scope of the appended claims, the invention may be practiced otherwise than as specifically described herein. The preferred embodiments of the invention have been illustrated and described in detail. However, the present invention is not to be considered limited to the precise construction disclosed. Various adaptations, modifications and uses of the invention may occur to those skilled in the art to which the invention relates and the intention is to cover hereby all such adaptations, modifications, and uses which fall within the spirit or scope of the appended claims.

All publications and patents mentioned in the above specification are herein incorporated by reference in their entirety.

Having described the invention, we claim:

1. A method of fabricating a consolidated multilayered gradient optical element, the method comprising:
extruding a first polymer component blended with varying amounts of at least one optical additive to form a plurality of films having varying concentrations of the at least one optical additive,
consolidating the plurality of films into a multilayered sheet having a gradient in optical properties defined by a gradient in concentration of the at least optical additive in the layers of the sheet, and
shaping the consolidated multilayered sheet into the consolidated gradient optical element.

2. The method of claim 1, wherein the concentration of the optical additives in the multilayered sheet varies across a plain normal to a thickness of the multilayered sheet to define the gradient in optical properties.

3. The method of claim 1, wherein the optical properties comprises at least one of absorption, reflection, refraction, transmission, polarization, and/or scattering.

4. The method of claim 1, wherein the plurality of films is consolidated by stacking films and laminating the films under pressure to obtain a flat multilayered sheet.

6. The method of claim 1, wherein the films are stacked in ordered layers to form a hierarchical multilayered gradient sheet; and wherein adjacent films are selected to exhibit progressively different optical properties.

7. The method of claim 1, wherein the at least one optical additive is substantially non-migratory upon consolidation of the films to provide the layers of the sheet with finite optical additive concentrations defined the concentrations of the at least one optical additive in the films prior to consolidation.

8. The method of claim 1, wherein each layer has a thickness of from about 5 nm to about 1,000 nm.

9. The method of claim 1, wherein from 5 to about 100,000 films are consolidated.

10. The method of claim 1, wherein the polymer component is selected from the group consisting of polyethylene naphthalate, an isomer thereof, a polyalkylene terephthalate, a polyimide, a polyetherimide, a styrenic polymer, a polycarbonate, a poly(meth)acrylate, a cellulose derivative, a polyalkylene polymer, a fluorinated polymer, a chlorinated polymer, a polysulfone, a polyethersulfone, polyacrylonitrile, a polyamide, polyvinylacetate, a polyether-amide, a styrene-acrylonitrile copolymer, a styrene-ethylene copolymer, poly(ethylene-1,4-cyclohexylenedimethylene terephthalate), polyvinylidene difluoride, an acrylic rubber, isoprene, isobutylene-isoprene, butadiene rubber, butadiene-styrene-vinyl pyridine, butyl rubber, polyethylene, chloroprene, epichlorohydrin rubber, ethylene-propylene, ethylene-propylene-diene, nitrile-butadiene, polyisoprene, silicon rubber, styrene-butadiene, urethane rubber, and polyoxyethylene, polyoxypropylene, and tetrafluoroethylene hexafluoropropylene vinylidene (THV), aromatic polyesters, aromatic polyamides, ethylene norbornene copolymers and blends thereof.

11. The method of claim 1, wherein the polymer component comprises a polycarbonate.

12. The method of claim 1, wherein the at least one optical additive exhibit nonlinear optical effects, the nonlinear optical effects comprising at least one of absorption, reflection, refraction, transmission, polarization, and/or scattering.

13. The method of claim 12, wherein the optical additive is an organic or inorganic dye, pigment, and/or nanomaterial.

14. The method of claim 1, wherein the consolidated multilayered sheet is shaped into the consolidated gradient optical element by thermoforming the sheet.

15. The method of claim 14, wherein the sheet prior to thermoforming has a substantially flat outer surface and an axial gradient of the at least one optical additive normal to the sheet outer surface.

16. The method of claim 15, wherein the thermoformed sheet has crescent shape and a spherical gradient concentration of the at least one optical additive.

17. The method of claim 1, wherein the sheets are shaped into a lens or optical flat having at least one of an axial or radial gradient of optical properties.

18. A multilayered gradient optical element, comprising:
a thermoformed multilayered polymer material having a gradient in at least one optical property that is defined a gradient in concentration of at least one optical additive in the layers of the material, the thermoformed multilayered material comprising a consolidated plurality of extruded polymer films having varying concentrations of the at least one optical additive.

19. The multilayered gradient optical element of claim 18, wherein the concentration of the optical additives in the multilayered sheet varies across a plain transverse to a thickness of the multilayered sheet to define the gradient in optical properties.

20. The multilayered gradient optical element of claim 18, wherein the optical properties comprises at least one of absorption, reflection, refraction, transmission, polarization, and/or scattering.

21. The multilayered gradient optical element of claim 18, wherein the plurality of films is consolidated by stacking films and laminating the films under pressure and/or vacuum to obtain a flat multilayered sheet.

22. The multilayered gradient optical element of claim 18, wherein the films are stacked in ordered layers to form a hierarchical multilayered gradient material; and wherein adjacent films are selected to exhibit progressively different optical properties.

23. The multilayered gradient optical element of claim 18, wherein the at least one optical additive is substantially non-migratory upon consolidation of the films to provide the layers of the material with finite optical additive concentrations defined by the concentrations of the at least one optical additive in the films prior to consolidation.

24. The multilayered gradient optical element of claim 18, wherein each layer has a thickness of from about 5 nm to about 1,000 nm.

25. The multilayered gradient optical element of claim 18, wherein from 5 to about 100,000 films are consolidated.

26. The multilayered gradient optical element of claim 18, wherein the polymer component is selected from the group consisting of polyethylene naphthalate, an isomer thereof, a polyalkylene terephthalate, a polyimide, a polyetherimide, a styrenic polymer, a polycarbonate, a poly(meth)acrylate, a cellulose derivative, a polyalkylene polymer, a fluorinated polymer, a chlorinated polymer, a polysulfone, a polyethersulfone, polyacrylonitrile, a polyamide, polyvinylacetate, a polyether-amide, a styrene-acrylonitrile copolymer, a styrene-ethylene copolymer, poly(ethylene-1,4-cyclohexylenedimethylene terephthalate), polyvinylidene difluoride, an acrylic rubber, isoprene, isobutylene-isoprene, butadiene rubber, butadiene-styrene-vinyl pyridine, butyl rubber, polyethylene, chloroprene, epichlorohydrin rubber, ethylene-propylene, ethylene-propylene-diene, nitrile-butadiene, polyisoprene, silicon rubber, styrene-butadiene, urethane rubber, and polyoxyethylene, polyoxypropylene, and tetrafluoroethylene hexafluoropropylene vinylidene (THV), aromatic polyesters, aromatic polyamides, ethylene norbornene copolymers and blends thereof.

27. The multilayered gradient optical element of claim 18, wherein the polymer component comprises a polycarbonate.

28. The multilayered gradient optical element of claim 18, wherein the at least one optical additive exhibit nonlinear optical effects, the nonlinear optical effects comprising at least one of absorption, reflection, refraction, transmission, polarization, and/or scattering.

29. The multilayered gradient optical element of claim 18, wherein the optical additive is an organic or inorganic dye, pigment, and/or nanomaterial.

30. The multilayered gradient optical element of claim 18, having at least one of an axial or radial gradient of optical properties.
